(19) United States
(12) Patent Application Publication
(10) Pub. No.: US 2026/0027508 A1
(43) Pub. Date: Jan. 29, 2026

(54) SORBENT UNIT, AND SYSTEM AND METHOD FOR PURIFICATION OF GAS

(71) Applicant: GREENCAP SOLUTIONS AS, Sandnes (NO)

(72) Inventor: Martin HOVDE, Sandnes (NO)

(21) Appl. No.: 18/852,046

(22) PCT Filed: Mar. 29, 2023
(86) PCT No.: PCT/NO2023/050069

§ 371 Date: Sep. 27, 2024

(30) Foreign Application Priority Data
Mar. 31, 2022 (NO) 20220393

(51) Int. Cl. B01D 53/04; B01J 20/18; B01J 20/28

(52) U.S. Cl. CPC B01D 53/0407; B01D 53/0446; B01J 20/18; B01J 20/28016; B01D 2253/108; B01D 2257/504; B01D 2257/80

(57) ABSTRACT

The present invention relates to a sorbent unit, comprising: sorbent beds at either side of a center volume; and side covers and bottom cover at the side and bottom of the center volume; wherein the sorbent unit above each sorbent bed has a casing and sorbent filling and discharging arrangements which are closed during operation to prevent any undesired gas escape. The present invention also relates to a system for purification of gas, comprising: at least one enclosure comprising a gas feed pipe, a gas exit pipe, and at least one sorbent unit according to the invention. The present invention also relates to a method for purifying gas.

### TECHNICAL FIELD

The present invention relates to an arrangement and containment of a physical adsorbent for the capture of H₂O and/or CO₂ from a dilute, gaseous source. The invention reveals flow direction of the gas containing H₂O or CO₂ and a support of the adsorbent which minimizes total volume and weight of the arrangement while maximizing the adsorbent area through which the gas flows. In addition, the arrangement minimizes or eliminates any mixing of incoming gas that contains H₂O and/or CO₂ and H₂O/CO₂ depleted outgoing gas using a very efficient design. More specifically, the present invention relates to enhancement of a reactor process for H₂O and/or CO₂ capture, using silica gel, zeolite or other solid adsorbent where there is a need for large surface area, shallow adsorbent bed depth and low pressure drop, where all adsorbent weight is supported by the unit floor, eliminating complex and heavy adsorbent support structures.

### BACKGROUND

Small porous particles such as zeolite or silica gel can selectively adsorb component(s) such as CO₂ or H₂O from dilute gaseous sources. The component(s) to be adsorbed or captured diffuse into the pores of the particles and are attached to certain locations or sites within the pores by electrical van der Waals forces. Once attached to a site, the adsorbed component(s) exerts or contributes less to the partial pressure of the component within the pores and hence at the particle surface. At constant temperature, this partial pressure is directly related to the concentration of the component(s). Thus, the concentration, measured for example in moles/m3, of the components in question is reduced in the gas near the particle surface. If the concentration of the same component is higher in the bulk gas phase, the component in question will diffuse or be transported from the bulk gas to the particle surface and into the particle pores where it may find suitable sites for attachment. In this way, the components in question are removed from the bulk gas.

Conversely, if the concentration of the component(s) in the bulk gas phase is lower than the concentration near the particle surface, the component(s) will tend to diffuse or be transported away from the particle surface and into the bulk gas. Simultaneously, some of the component(s) attached within the pores of the particle will be released and diffuse to the particle surface and from there into the bulk gas phase.

The amount of component(s) the particle can hold depends on the properties of the component in question such as dipole or quadrupole momentum and the molecular size. It also depends on the properties of the particle and, significantly, on the system temperature. Usually, the particle can hold more of a component at lower temperature such as 0° C. or lower, and less at higher temperatures. At very high temperature, such as 150 to 300° C., particles typically hold only very small amounts of the components.

For a specific sorbent there are correlations between amount of adsorbed component(s) the porous particles can hold, for example measured in moles component per kg particles, and the partial pressure of the adsorbate in the bulk gas phase, for example measured in kPa. Such correlations are called isotherms. A plot of isotherms will show amount of adsorbate (y-axis) as function of gas phase component partial pressure (x-axis), indicated by lines in the diagram, each of the lines referring to some specified and fixed temperature.

Based on this it is possible to adsorb selected components from a gas passing over a packed bed of porous particles. These components can then be released by manipulating the temperature and/or the partial pressure of the component in the gas phase. In this way the gas can be purified by removing components or the components can be collected from the gas for some useful application.

A typical process for the collection of selected components from a gas is comprised of two or more vertical cylindrical tanks, each containing a packed bed of porous particles. Gas to be purified enters from the top, flows through the packed bed and exits at the bottom of the container. The selected components are adsorbed into the particles.

The packed beds alternate between adsorption and regeneration modes. Normally only one of the beds is regenerated at a time. During regeneration a small side-draw of the purified gas from the adsorbing beds is heated and directed via a heater to the bed being regenerated. When the whole packed bed has reached a pre-determined temperature, the regeneration is complete. If the gas purification is gas dehydration, the hot regeneration gas may be cooled to remove desorbed H₂O, then re-cycled to the system feed stream for re-purification.

An example of the use of processes similar as described above is the purification or removal of H₂O from natural gas before liquefaction of the gas. This prevents ice formation in the cryogenic liquefaction process.

A second example is the removal of H₂O from a stream of CO₂ gas before cooling and liquefaction of the CO₂. Again, the purpose is to prevent the formation of free water and ice in a subsequent liquefaction process.

A third example of the use of packed beds of particles for the adsorption of components from a gas steam, is the removal of CO₂ from circulating breathing gas in diving equipment.

A fourth example, is the use of packed beds of particles to remove CO₂ from the atmosphere within spacecraft in order to maintain a healthy gas for breathing. An earlier invention, WO2018/034570, presented a system for the enforcement of humidity, temperature, and CO₂ concentration within greenhouses. This is achieved by closing of the greenhouse. Air is extracted at a high rate from the closed greenhouse, dehumidified, temperature adjusted by cooling followed by re-heating, enriched in CO₂ using CO₂ captured from outside air, adding supplementary CO₂ captured from the outside air, and subsequently returned to the greenhouse. This stabilizes the greenhouse temperature and humidity and eliminates CO₂ emissions caused by ventilation. The CO₂ was captured from the air using packed beds of suitable adsorbents and passing air over these packed beds. A second earlier invention, PCT/NO2021/050095, reveals a more elaborate method to capture CO₂ from air whereby moisture is temporarily removed from the air using revolving wheels coated with an adsorbent that has affinity for H₂O but not CO₂. Next, the CO₂ is captured in a packed bed of suitable porous particles. The dehydrated and CO₂ depleted air is subsequently used to assist the regeneration of the revolving dehydration wheels.

The direct capture of CO₂ from air, abbreviated DAC (Direct Air Capture) has recently gained significant interest as a means to limit climate change. Such facilities could provide negative emissions, and this could be assigned to positive emissions to annul these.

Hence there is a need for a CO₂ capture system that can capture CO2 from air, from intermediate and low concentration CO₂ sources, and also from higher concentration sources such as flue gas, without major modifications. The energy consumption must be minimized and the less energy required, the bigger the market for DAC systems.

The capture of CO₂ from air is under development by some players. One example is the contacting of aqueous potassium hydroxide with air. The hydroxide reacts with CO₂ to form potassium carbonate. A major challenge with this is the complexity and energy needed to regenerate the potassium hydroxide solution.

WO 2013075981 A3 describes a method for extracting CO₂ from air by adsorption on a solid adsorbent. The solid sorbent is functionalized using amine compounds that react with CO₂. However, such systems cannot remove CO₂ completely from the air, to levels below for example 10 to 20 ppm. In addition, during regeneration of the adsorbent, the amine compounds are exposed to hot air with high concentrations of oxygen, causing potential degradation to toxic and possibly carcinogenic by-products.

U.S. Pat. No. 7,861,719 B1 describes air-purifying filters and more particularly replaceable filter modules especially suited for use in breathing apparatuses. The filter modules do not have sorbent filling and discharging arrangements, and are not suitable for being operated in a vertical position since this would cause the particulate sorbent to sink and thereby leave a space in the upper part of the filter which would cause leakage of air. People skilled in the art would know that a packed bed of sorbent particles is normally not referred to as a filter.

Large scale capture of CO₂ from very dilute sources such as air will require the treatment of very large air flows. This air must be supplied by fans, where the fan work must be minimized. This place demands on the packed beds of porous particles. The surface area seen by the incoming air must be large and the air velocity low. This reduces air pressure losses in the packed bed. In addition, the thickness or depth of the packed bed must be small, also minimizing pressure drop. The thickness must furthermore be suitable for the relatively small amounts of CO₂ that shall be captured. Beyond this there must be no possibility for leakage of CO₂₋containing gas to the purified, CO₂ depleted gas exit stream.

Additional requirements are low packed bed footprint, low weight and easy production. This eliminates packed beds in containers which has small surface area as seen by the gas, a deep packed bed of particles and less demand for low pressure drop.

This invention describes a novel design for packed bed containment which satisfies the demands required when capturing large amounts of CO2 from dilute sources, with minimum energy consumption, minimum size and weight and efficient production and maintenance.

### SUMMARY OF THE INVENTION

The present invention relates to a sorbent unit, comprising: sorbent beds at either side of a center volume; and side covers and bottom cover at the side and bottom of the center volume; wherein the sorbent unit above each sorbent bed has a casing and sorbent filling and discharging arrangements which are closed during operation to prevent any undesired gas escape.

The present invention also relates to a system for purification of gas, comprising: at least one enclosure comprising a gas feed pipe, a gas exit pipe, and at least one sorbent unit according to the present invention.

The present invention also relates to a method for purifying gas, comprising: flowing gas into at least one enclosure, wherein the at least one enclosure comprises a gas feed pipe, a gas exit pipe, and at least one sorbent unit according to the present invention; flowing the gas substantially horizontally through the sorbent beds, wherein the gas is purified, and into the center volume of the sorbent unit; flowing the purified gas substantially vertically out of the center volume, collecting the purified gas in a gas exit pipe, and flowing the purified gas out of the at least one enclosure.

Further embodiments of the sorbent unit, system and method according to the present invention are described in the dependent claims.

The object of the present invention is to facilitate and significantly enhance the capture of low concentration gas components such as CO₂ and H₂O at low pressures such as atmospheric pressure. The focus is to minimize pressure drop through sorbents, minimize the amount of sorbent needed, and minimize unit footprint and weight. A second focus is to minimize the weight and cost of the structure and arrangements used to contain the sorbent, in particular, by a design that places the load or weight of the sorbent on a system floor. A third focus is to ensure no leakage of incoming, contaminated gas into purified gas downstream of the sorbent with the simplest possible arrangement.

The object may be achieved by employing substantially horizontal flow of gas through sorbent beds, employing a center volume into which gas can flow substantially horizontally, exclusively through sorbent particles, from at least two opposite directions. Between the sorbent beds there is a center volume from which the H₂O/CO₂ depleted air can escape.

The CO₂ shall be desorbed as nearly pure CO₂ or as a mixture of CO₂ and air, suitable for many useful applications including the supply of “green” CO₂ to greenhouses. The main object is to reduce energy consumption, in particular high value energy such as electric or high temperature (above 80 to 100° C.) to an absolute minimum. The focus is on energy required to de-hydrate gas prior to CO₂ capture, utilizing synergies between the dehydration process and the zeolite system, in particular the property of the zeolite system that it will capture any trace of residual water in the gas. The latest commercially available technologies, including air handling which is developing rapidly to reduce energy consumption, shall be utilized to the extent possible.

### Figures

FIG. 1 is a schematic drawing of the basic principle of the invention including gas flow directions, packed beds and packed bed supports.

FIG. 2 is a schematic drawing of the basic principle of the invention seen from the side including gas flow directions, packed bed supports or lattice-works, mesh with openings smaller than the adsorbent particles and the packed beds of adsorbent particles.

FIG. 3 shows and clarifies a practical embodiment of a part of the invention, a sorbent unit, seen from the direction of gas inlet flow.

FIG. 4 shows and clarifies a practical embodiment of a part of the invention, a sorbent unit, seen from above and slightly to the side.

FIG. 5 shows and further clarifies a practical embodiment of the invention, a sorbent unit, with expanded and more detailed view of the top part. The top part is cut vertically in half and the view is of the back half part.

FIG. 6 shows and further clarifies a practical embodiment of the invention, a sorbent unit, with expanded and more detailed view of the top part. The top part is complete, only the bottom part is removed.

FIG. 7 shows and further clarifies a practical embodiment of the invention, a sorbent unit, seen from below with all but one of the lattice-works removed.

FIG. 8 shows three sorbent units located within a common enclosure. The enclosure is seen from the side.

FIG. 9 shows three sorbent units located within a common enclosure. The enclosure is seen from the top.

FIG. 10 shows an illustration for a first example, a sorbent unit located within an enclosure.

FIG. 11 shows a second illustration for the first example, CO₂ content trend in gas outlet from the sorbent unit.

FIG. 12 shows a third illustration for the first example, CO₂ profile in the gas between sorbent particles at the time of initial CO₂ breakthrough.

FIG. 13 shows a fourth illustration for the first example, sorbent loading profile at the time of initial CO₂ breakthrough.

FIG. 14 shows a first illustration for a second example, three sorbent units located within an enclosure.

FIG. 15 shows a first illustration for a third example, six sorbent units located within an enclosure.

### DETAILED DESCRIPTION OF THE INVENTION

The present invention relates to a sorbent unit, comprising sorbent beds at either side of a center volume; and side covers and bottom cover at the side and bottom of the center volume; wherein the sorbent unit above each sorbent bed has a casing and sorbent filling and discharging arrangements which are closed during operation to prevent any undesired gas escape.

Preferably, the sorbent unit is configured to allow gas feed to flow substantially horizontally through the sorbent beds, wherein the gas is purified, and into the center volume, to flow the purified gas out of the center volume, and to collect the purified gas.

The sorbent beds may be sorbent particle beds. The sorbent beds may be packed sorbent beds. The packed sorbent beds may have packed bed supports. The packed sorbent beds may be supported by lattice works and mesh at either side of the sorbent beds. Preferably, the sorbent bed thickness at any point does not deviate more than 2% of the average thickness, preferably not more than 1%, more preferably not more than 0.5%. The sorbent bed thickness may be >2 cm. The sorbent of the sorbent beds may comprise sorbent beads having a sorbent bead size <5 mm. The sorbent of the sorbent beds may be selected from the group of CO₂ sorbent, H₂O sorbent, zeolite, silica gel, or other solid absorbent. Preferably, the sorbent of the sorbent beds is zeolite 13×.

The sorbent unit may at the bottom be supported by a frame and supports.

Preferably, the supports provide an open space between the frame of the sorbent unit and a floor of an enclosure on which the sorbent unit rests to allow distribution of gas feed through the open space under the sorbent unit.

Preferably, the casing above each sorbent bed is configured to allow filling of extra sorbent above the sorbent beds and thereby allow the sorbent to sink or settle without creating a leakage or short-cut for the gas through the top of the sorbent beds.

The present invention also relates to a system for purification of gas, comprising at least one enclosure comprising a gas feed pipe, a gas exit pipe, and at least one sorbent unit according to the present invention.

Preferably, the system is configured to allow gas feed entering the at least one enclosure through the gas feed pipe to flow substantially horizontally through the sorbent beds, wherein the gas is purified, and into the center volume, flowing the purified gas out of the center volume, collecting the purified gas in the gas exit pipe, and flowing the purified gas out of the at least one enclosure.

The at least one enclosure may comprise two or more sorbent units arranged in parallel. The system may comprise two or more enclosures arranged in series and/or parallel.

The present invention also relates to a method for purifying gas, comprising flowing gas into at least one enclosure, wherein the at least one enclosure comprises a gas feed pipe, a gas exit pipe, and at least one sorbent unit according to the present invention; flowing the gas substantially horizontally through the sorbent beds, wherein the gas is purified, and into the center volume of the sorbent unit; flowing the purified gas substantially vertically out of the center volume, collecting the purified gas in a gas exit pipe, and flowing the purified gas out of the at least one enclosure.

Preferably, gas flows through the sorbent beds from at least two opposite directions and into the center volume. When two enclosures are run in parallel, the two enclosures may alternate between adsorption and desorption modes. Flowing of the gas in the system may be effected by fans.

In the following, the terminology will be as follows: While in the gas phase, the component to be adsorbed is referred to as the adsorbate. In this invention this usually refers to H₂O or CO₂ in air or other gas that is not adsorbed. Once the component to be adsorbed is on the particle surface, it is referred to as the adsorbate. The porous particle into which the component diffuses and is adsorbed is referred to as the adsorbent or, for reversible processes, the sorbent. In this invention this usually means zeolite or silica gel.

The particles may have various shapes such as cylindrical or spherical. The terminology will be particles or in some cases beads which usually means spherical particles. However whichever terminology is used this does not necessarily limit the shape of the particles to spherical.

In the present description and claims the terms “humidity” and “absolute humidity” are used as a measure of the true water vapour content of air (g/m3). The term “relative humidity” of an air-water vapour mixture is used as a measure of the ratio of the actual content of water vapour in the air to the content of water vapour in the air if the air had been saturated at the temperature in question. The term “CO₂ concentration” is a measure of the number of molecules of CO₂ in the air relative to the total number of gas molecules in the air. It is measured in ppm or parts per million.

The pressure is herein given as “atmospheric”. Accordingly, 1.013 bara is the normal atmospheric pressure at sea level. In SI units, 1 bar corresponds to 100 kPa.

The terms “gas” and “air” are used interchangeably and refers mostly to air but may also refer to air contaminated with extra amounts of CO₂ such as flue gas from combustion processes.

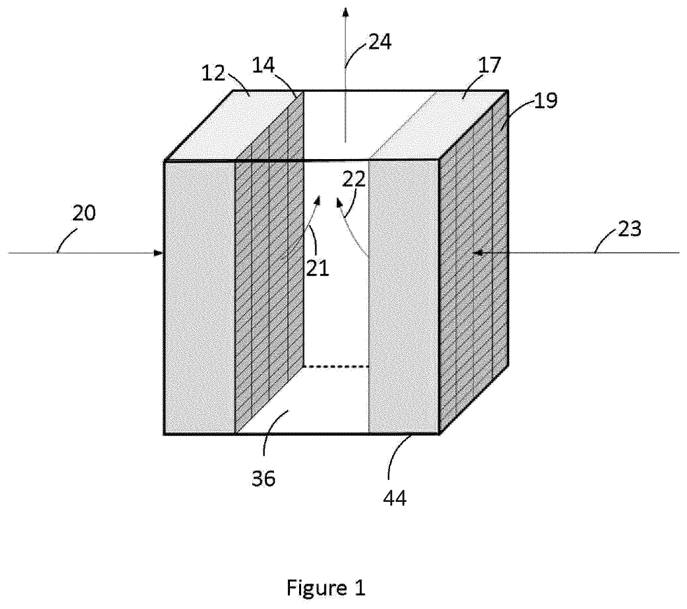

FIG. 1 is a principle overall sketch of a sorbent unit according to the present invention. It shows gas flows 20 and 23 with component(s) to be removed from the gas, adsorbate(s), flowing to packed beds of sorbents 12 and 17 respectively. After the adsorption process, upon leaving the packed sorbents 12 and 17, the two gas streams enter a common center volume 36. This is shown as streams 21 and 22. The mixed stream exits the volume 36 in a stream 24.

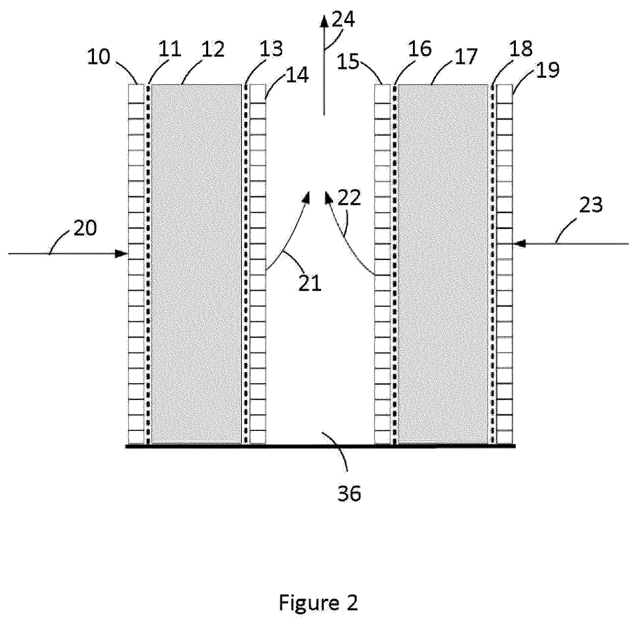

FIG. 1 also shows two lattice works 14 and 19. These form parts of the sorbent packed bed containment. The unit in FIG. 1, called a sorbent unit, is indicated as a near cubic form 44. In practise, it will be rectangular, preferred width up to about 1 m. If wider design is preferred, sorbent units may be installed side by side. The sorbent unit height may be up to several meters such 2, 3 or 4 meters. The sorbent thickness is typically more than 2 cm, preferred 10 to 35 cm, even more preferred 15 to 25 cm. The sorbent unit 44 is closed such that the only entrance for gas is as shown by streams 20 and 23, via sorbent beds 12 and 17. The only gas exit is on the top, via stream 24. FIG. 2 shows details of the sorbent containment within the sorbent unit. Incoming gas, stream 20 flows through a lattice work 10. The lattice works supports a mesh 11. The mesh has openings smaller than the size of the sorbent particles. Next, there is a packed bed of sorbent particles 12 and at the end, a second mesh 13 supported by a lattice work 14 after which the gas exits in the stream 21 into the volume 36. Similarly, incoming gas, stream 23 flows through a lattice work 19. The lattice works supports a mesh 18. The mesh has openings smaller than the size of the sorbent particles. Next, there is a packed bed of sorbent particles 17 and at the end, a second mesh 16 supported by a lattice work 15 after which the gas exits in the stream 22 into the volume 36. The construction tolerance of the mesh and lattice works is preferably such that the sorbent bed thickness at any point does not deviate more than 2% of the average thickness. Preferred tolerance is 1% deviation, even more preferred 0.5%.

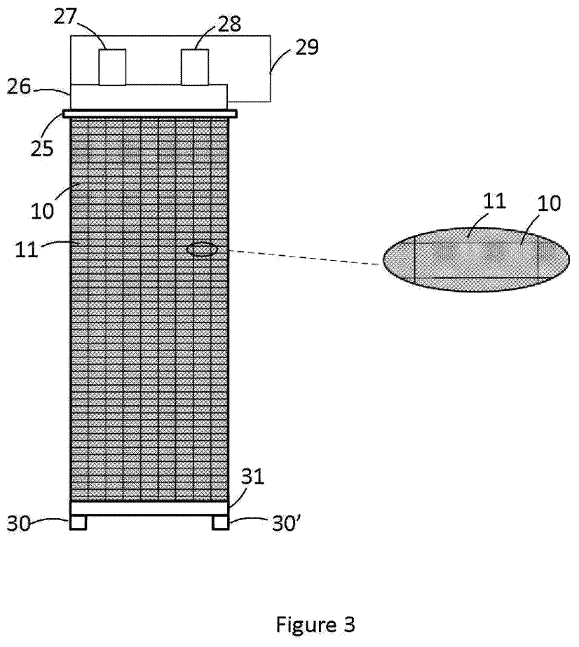

FIG. 3 shows a practical, preferred embodiment of the sorbent unit. The view is from the side of the entering gas stream 20 (not shown in FIG. 3), via lattice work 10 and mesh 11. The sorbent unit is supported by a frame 31 and the complete weight will be carried by supports 30 and 30′. This enables the sorbent unit to be located on the floor of an enclosure as will be discussed later.

On top of the sorbent unit there is a top section support 25 for a casing 26 comprising a volume directly above the sorbent bed, filling and discharging arrangements shown as pipes 27 and 28 suitable for filling and discharging sorbent particles. A gas exit pipe 29, with a not shown opening facing downward into the not shown volume 26, is used to collect gas discharge from the sorbent beds.

The casing 26 allows filling of extra sorbent above the sorbent beds and thereby allows the sorbent to sink or settle without creating a leakage or short-cut for the gas through the top of the sorbent beds.

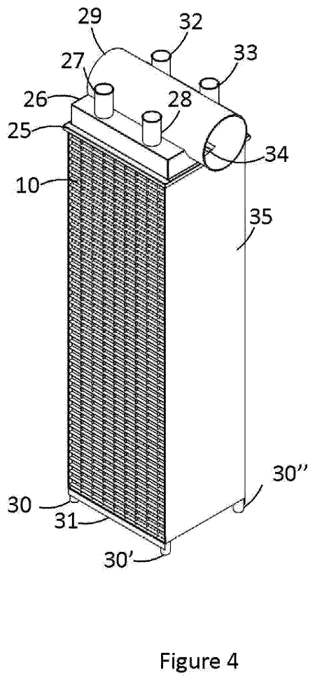

FIG. 4 shows a sorbent unit at an angle different from FIG. 3. The not shown gas stream 20 enters the unit through the lattice work 10 and the not shown mesh 11. At the bottom of the sorbent unit the frame 31 and supports 30, 30′ and 30″ are shown. A side cover 35 prevents gas from entering the not shown internal volume 36 without passing through a sorbent bed. The top of the sorbent unit shows the top section support 25, the casing 26, the sorbent filling and discharging pipes 27 and 28 located directly above the not shown sorbent bed 12, sorbent filling and discharge arrangements 32 and 33 located above the not shown sorbent packed bed 17, and the casing 26 with an opening 34 directly above the not shown volume 36.

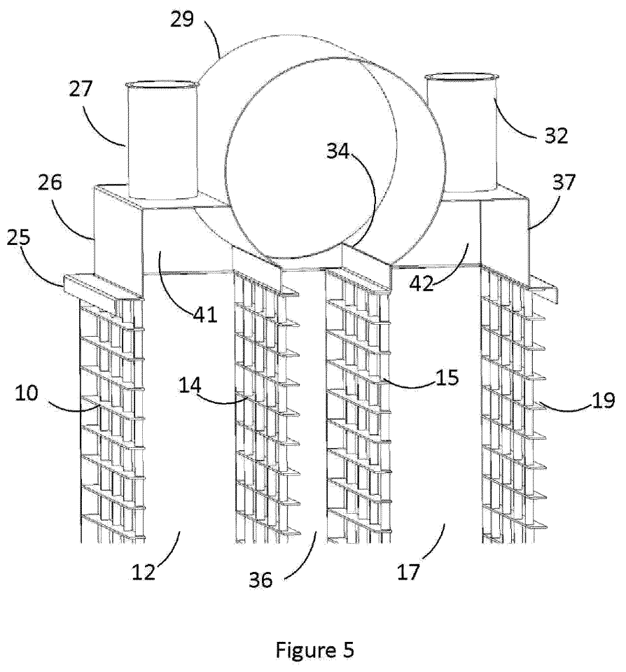

FIG. 5 shows the top of the sorbent unit, cut vertically to illustrate the view from inside the unit. This shows the upper part of the lattice works 10, 14, 15 and 19. The associated mesh 11, 13, 16 and 18, respectively, are omitted for clarity. Packed beds of sorbent 12 and 17 are shown on each side of the internal volume 13 that receives treated gas.

The top section support 25 and casing 26 show that these create a volume 41 above the sorbent bed 12. This volume is partly or fully filled with sorbent. This prevents gas from bypassing above the sorbent bed. Similarly, a casing 37 comprises a volume 42 that is partially or fully filled with sorbent beads, preventing any gas bypass of the packed sorbent bed 17.

FIG. 5 also shows sorbent filling and discharging pipes 27 and 32, and clarifies the design of the opening 34 in gas exit pipe 29. This opening receives treated gas and directs this gas in a desired direction for discharge or some useful application.

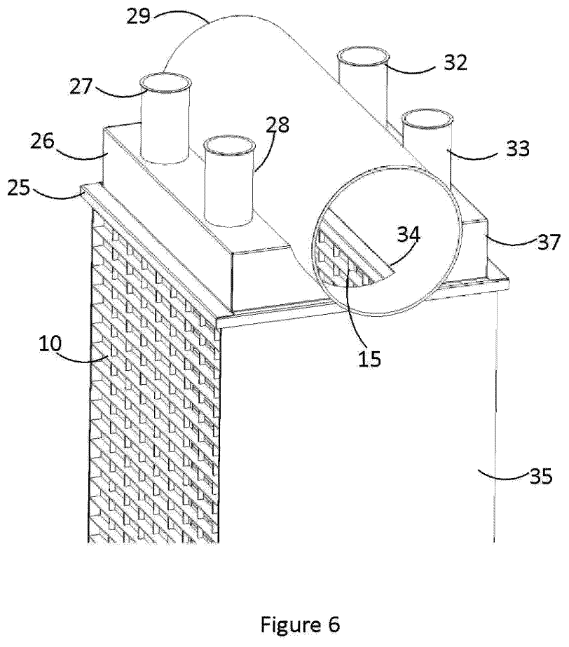

FIG. 6 shows the top of a sorbent unit from outside the unit. The cover 35 prevents gas from bypassing the sorbent beds. FIG. 6 also shows lattice works 10 and 15. The associated mesh 11 and 16 are omitted for clarity. The top section support 25, as shown earlier, supports the casings 26 and 37, providing not shown volumes above the sorbent beds 12 and 17, respectively. In addition, the sorbent filling and discharging pipes 27 and 28, above the sorbent bed 12, and the sorbent filling and discharge pipes 32 and 33 above the sorbent bed 17 are shown. These pipes are closed during normal sorbent unit operation, preventing any undesired gas escape.

Beyond this, FIG. 6 further clarifies the design of the treated gas exit pipe 29 with the gas opening 34 located above the volume 36.

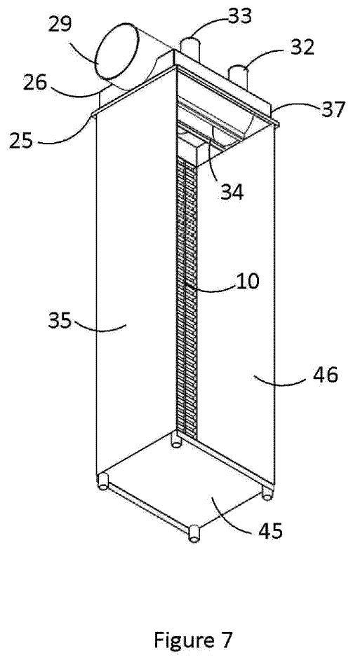

FIG. 7 shows the sorbent unit from below to further clarify the design. All internals except the lattice works 10 have been removed. Unit covers that force the gas through sorbent, briefly mentioned as part of the description of FIG. 6 are all shown. This includes the side cover 35, a bottom cover 45 and a side cover 46 opposite of the side cover 35.

In addition, the usual top arrangement is shown with the top section support 25, casings 26 and 37 for not shown volumes 41 and 42 (this was shown in FIG. 5), sorbent filling and discharge pipes 32 and 33, and the treated gas exit pipe 29 with opening 34.

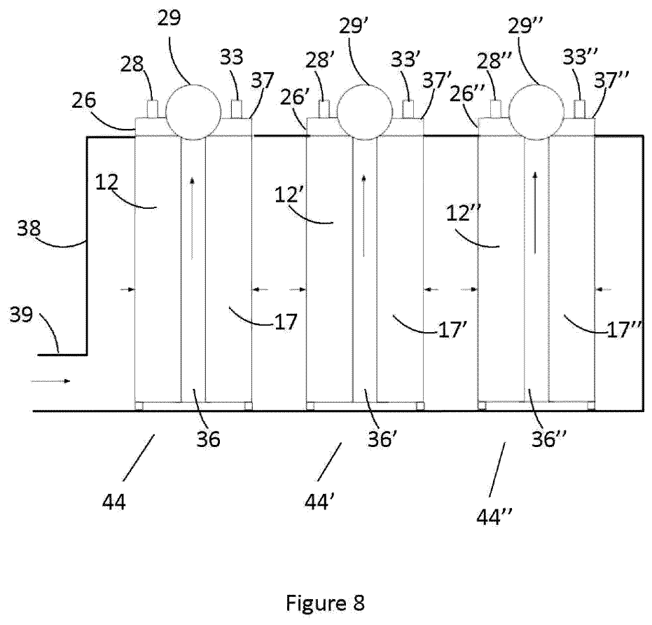

FIG. 8 is a side view of three sorbent units 44, 44′ and 44″ inside an enclosure 38, with a gas feed pipe 39. Sorbent unit 44 is illustrated with sorbent beds 12 and 17, volume 36 and top arrangement with casings 26 and 37, sorbent filling and discharge pipes 28 and 33 and treated gas exit pipe 29.

Similarly, for the sorbent unit 44′, sorbent beds 12′ and 17′, volume 36′ and top casings 26′, 37′, sorbent filling and discharge pipes 28′, 33′ and gas exit pipe 29′ are shown.

In addition, for the sorbent unit 44″, sorbent beds 12″ and 17″, volume 36″ and top casings 26″, 37″, sorbent filling and discharge pipes 28″, 33″ and gas exit pipe 29″ are shown.

The enclosure 38 can be made for any number of sorbent units. This enables the production of large capacity systems, without the need to develop a variety of sorbent unit sizes.

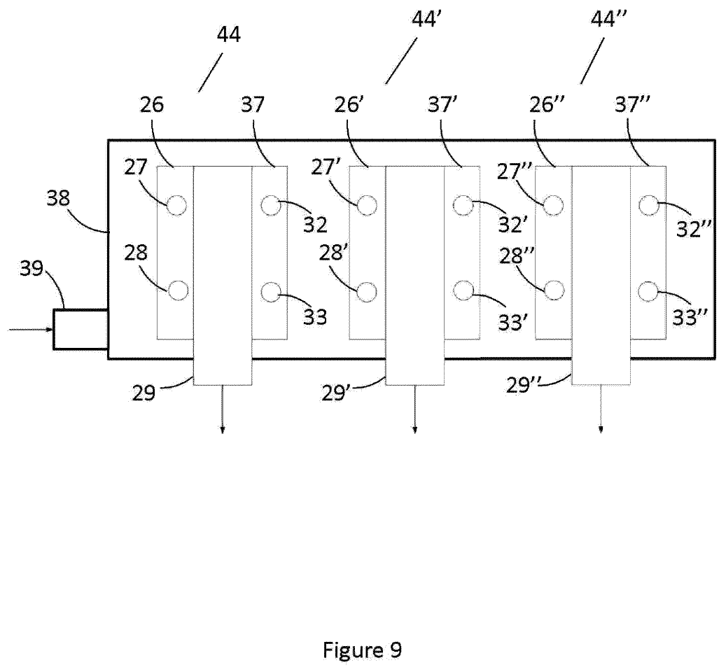

FIG. 9 shows the enclosure 38 and gas feed pipe 39 from above. Sorbent units 44, 44′ and 44″ are also shown from above. This covers the treated gas exit pipes 29, 29′ and 29″ with arrows indicating the direction of treated gas flow.

The treated gas exit pipes 29, 29′ and 29″ may in one embodiment be combined into a single exit pipe, inside or outside the enclosure (not shown).

In addition, the casings 26 and 37, 26′ and 37′ and 26″ and 37″ are shown, covering the not shown volumes 41 and 42, 41′ and 42′ and 41″ and 42″, respectively.

All pipes for filling and discharging sorbent are shown, including pipes 27 and 28 above not shown packed sorbent bed 12 and pipes 32 and 33 above not shown packed bed 17. Similarly, pipes 27′ and 28′ and 32′ and 33′ are shown, located above not shown beds 12′ and 17′, respectively. Furthermore, pipes 27″ and 28″ and 32″ and 33″ are shown, located above not shown beds 12″ and 17″, respectively.

People skilled in the art will understand that instead of one CO2 adsorbent systems as bed as shown in FIG. 8, two enclosures in parallel may be used. The two enclosures will alternate between adsorption and desorption modes.

### Example 1

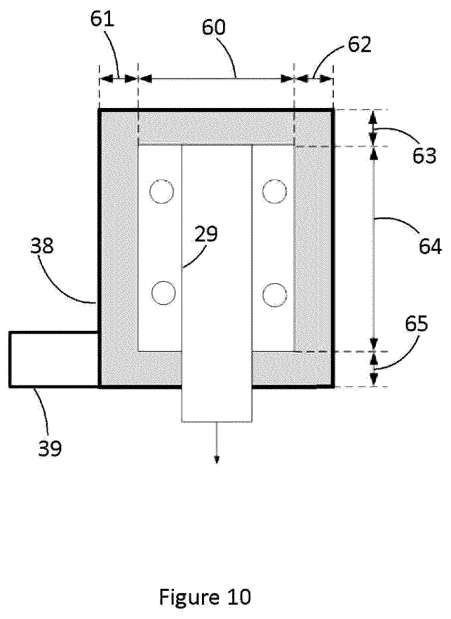

Example 1 is illustrated in FIG. 10. A sorbent unit is placed inside an enclosure 38 with a gas feed pipe 39. This is seen from above. Selected dimensions are shown in Table 1 below:

TABLE 1

| Reference # | Distance mm |
|---|---|
| 60 | 750 |
| 61 | 250 |
| 62 | 250 |
| 63 | 250 |
| 64 | 1000 |
| 65 | 250 |

The sorbent unit is located 250 mm from each corner in the enclosure 38. This leaves space around the sorbent unit for incoming gas to access both sorbent beds 12 and 17 (not visible from above). The distance 60 is comprised of the two sorbent beds 12 and 17 each with thickness 250 mm and the sorbent unit internal volume 36 with breadth 250 mm, total 750 mm. The space occupied by lattice works 10 and 19 and mesh 11 and 18 (not shown in FIG. 10) are ignored in this example.

The height of the packed beds is 2000 mm. Based on this the total footprint of the sorbent unit is 0.75 m² and that of the enclosure is 1.875 m². The total sorbent area facing incoming gas is 4 m², two beds each one meter wide and two meters high.

The total sorbent volume is 4 * 0.25 m³or 1 m³. With a bulk density of about 750 kg/m³ the sorbent weight is 750 kg. The sorbent weight is resting on the enclosure floor.

An example operation of the system employs data as shown in Table 2.

TABLE 2

| Variable | Value | |
|---|---|---|
| Gas flow | 0.8 | m³/s |
| Pressure | atmospheric | |
| Temperature | 0° | C. |
| Humidity | ignored | |
| Gas CO₂ content | 420 | ppm |
| Sorbent capacity | about 0.56 moles CO₂/kg | |
| Bead size | 2 | mm |

| | |
|---|---|
| Sorbent | Zeolite 13X |

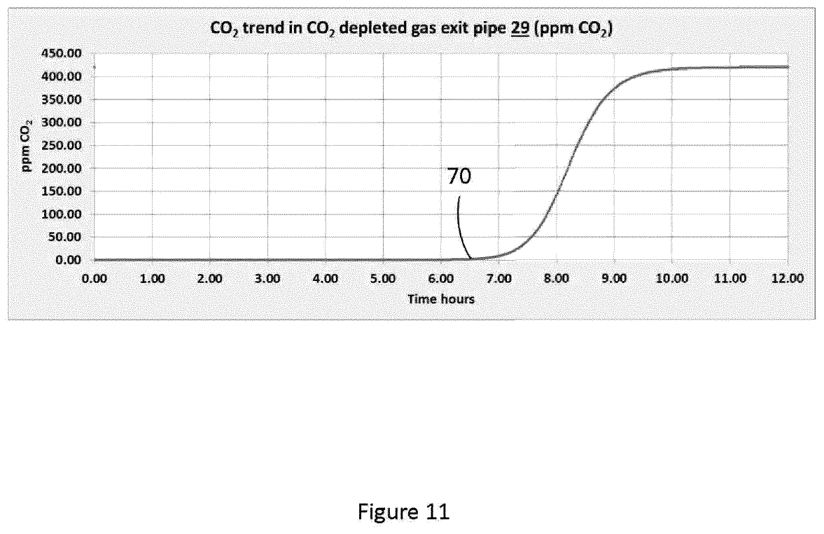

FIG. 11 shows CO₂ concentration in parts per million, ppm, in the sorbent unit gas exit pipe 29 as function of time. The concentration stays below about 1 ppm the first 6.5 hours. At 6.5 hours operation time this CO₂ concentration begins to increase, shown as 70. Thereafter the concentration increases until all the sorbent is saturated at the conditions shown in Table 2. The CO₂ concentration in the sorbent unit gas exit pipe 29 is then equal to the concentration in the incoming air, 420 ppm.

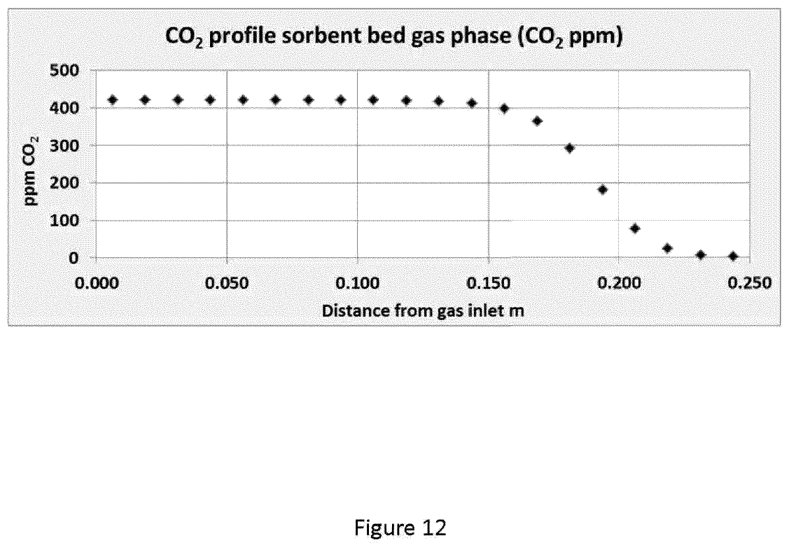

FIG. 12 shows CO₂ concentration in the sorbent bed gas phase, between the sorbent beads, at the time of CO₂ breakthrough. The first 15 cm of the bed the sorbent is saturated and the CO₂ concentration in the gas phase is the same as in the incoming air, 420 ppm. Beyond 15 cm the concentration gradually decreases and is about 1 ppm at the sorbent bed outlet, 25 cm from the bed inlet.

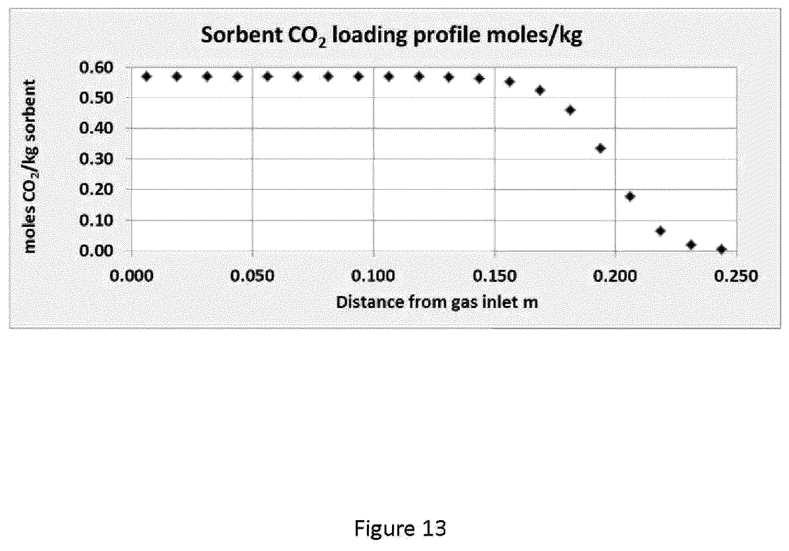

FIG. 13 shows the CO₂ loading in the sorbent at the time of CO₂ breakthrough, 6.5 hours into the CO₂ adsorption operation. Beyond 15 cm the loading gradually decreases and at the outlet it is very close to 0, as no CO₂ has been adsorbed at this point.

### Example 2

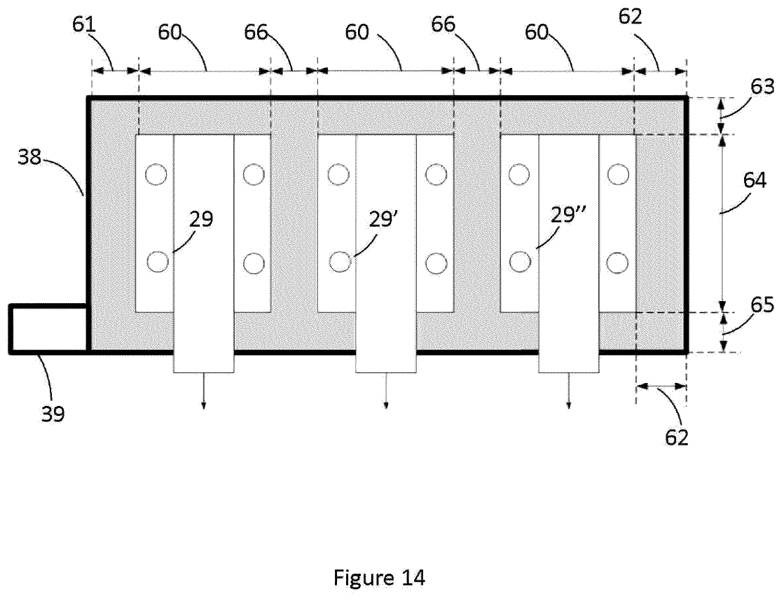

Example 2 is illustrated in FIG. 14. Three sorbent units are placed inside an enclosure 38 with a gas feed pipe 39. This is seen from above. Selected dimensions are shown in Table 3 below:

TABLE 3

| Reference # | Distance mm |
|---|---|
| 60 | 750 |
| 61 | 250 |
| 62 | 250 |
| 63 | 250 |
| 64 | 1000 |
| 65 | 250 |
| 66 | 250 |

The sorbent units are located 250 mm from each corner in the enclosure 38. The distance between the units is 250 mm. This leaves space around each sorbent unit for incoming gas to access all sorbent beds. Similar to Example 1, the distance 60 is comprised of the two sorbent beds 12 and 17 (not shown), each with thickness 250 mm. The sorbent unit internal volume 36 with breadth is 250 mm, and therefore the sorbent unit total 60 is 750 mm.

The height of the packed beds is 2000 mm. Based on this the total footprint of the sorbent units is 2.25 m² and that of the enclosure is 4.875 m². The total sorbent area facing incoming gas is 12 m², six beds each one meter wide and two meters high.

The total sorbent volume is 3 m³. With a bulk density of about 750 kg/m³ the sorbent weight is 2250 kg. The sorbent weight is resting on the enclosure floor.

### Example 3

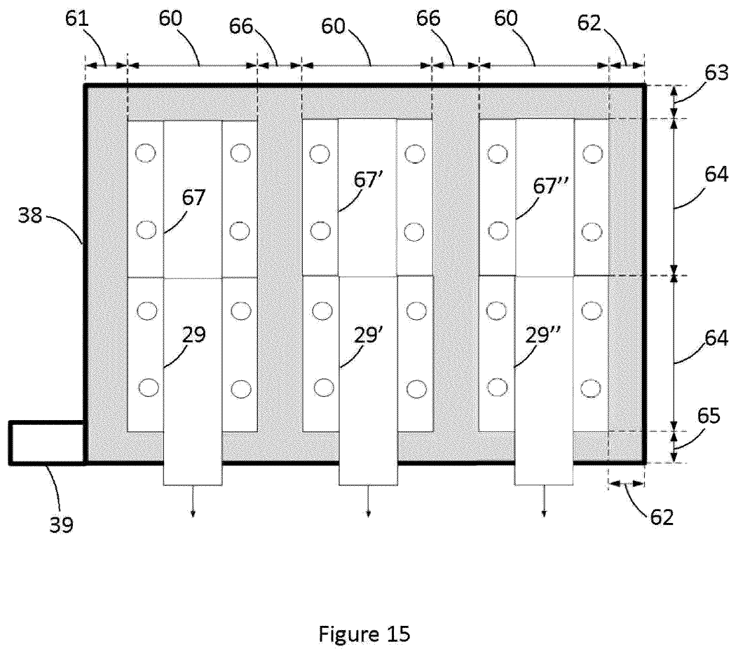

Example 3 is illustrated in FIG. 15. Six sorbent units are placed inside an enclosure 38 with a gas feed pipe 39. This is seen from above. Selected dimensions are shown in Table 4 below:

TABLE 4

| Reference # | Distance mm |
|---|---|
| 60 | 750 |
| 61 | 250 |
| 62 | 250 |
| 63 | 250 |
| 64 | 1000 |
| 65 | 250 |
| 66 | 250 |

The sorbent units are located 250 mm from each corner in the enclosure 38. The distance between the units is 250 mm. This leaves space around each sorbent unit for incoming gas to access all sorbent beds. Similar to Examples 1 and 2, the distance 60 is comprised of the two sorbent beds 12 and 17 (not shown), each with thickness 250 mm. The sorbent unit internal volume 36 with breadth is 250 mm, and therefore the sorbent unit total breadth 60 is 750 mm.

Three of the sorbent units have shortened gas exit pipes 67, 67′ and 67″. These pipes are connected to the other sorbent unit gas exit pipes 29, 29′ and 29″ respectively, leading treated gas away from the sorbent units and the associated enclosure 38.

The height of the packed beds is 2000 mm. The total footprint of the sorbent units is 4.5 m², twice that of Example 2 and six times that of Example 1, and the footprint of the enclosure is 8.125 m². The total sorbent area facing incoming gas is 24 m², twelve beds each one meter wide and two meters high.

The total sorbent volume is 6m³. With a bulk density of about 750 kg/m³ the sorbent weight is 4500 kg. The sorbent weight is resting on the enclosure floor.

The basic idea of this invention is to flow gas through sorbent beds from two sides, leading into a common volume, from which the treated gas can exit.

People skilled in the art will understand that other configurations are possible based on this basic idea. As an example, the sorbent bed might be circular, in the form of an annulus, with an inner circular volume collecting the treated gas.

Another possibility is a hexagonal bed, with an outer and an inner hexagon, where gas may flow from the outside of the outer hexagon through the bed to an inner hexagon shaped volume from which it can exit the system.

People skilled in the art will also understand that gas flow direction might be first to the inner volume, in the opposite direction from the inner volume to the outer volume. This would be used mainly for sorbent regeneration.

It is furthermore understood that the sorbent units and/or the enclosure must be well insulated such that only small amounts of heat is lost during high temperature sorbent regeneration.

1. A sorbent unit, comprising:
sorbent beds at either side of a center volume; and
side covers and bottom cover at the side and bottom of the center volume;
wherein the sorbent unit above each sorbent bed has a casing and sorbent filling and discharging arrangements which are closed during operation to prevent any undesired gas escape.

2. The sorbent unit according to claim 1, wherein the sorbent unit is configured to allow gas feed to flow substantially horizontally through the sorbent beds, wherein the gas is purified, and into the center volume, to flow the purified gas out of the center volume (36), and to collect the purified gas.

3. The sorbent unit according to claim 1, wherein the sorbent beds are sorbent particle beds.

4. The sorbent unit according to-any of the preceding claims claim 1, wherein the sorbent beds are packed sorbent beds.

5. The sorbent unit according to claim 4, wherein the packed sorbent beds have packed bed supports.

6. The sorbent unit according to claim 4, wherein the packed sorbent beds are supported by lattice works and mesh at either side of the sorbent beds.

7. The sorbent unit according to claim 1, wherein the sorbent bed thickness at any point does not deviate more than 2% of the average thickness, preferably not more than 1%, more preferably not more than 0.5%.

8. The sorbent unit according to any of the preceding claims claim 1, wherein the sorbent bed thickness is >2 cm.

9. The sorbent unit according to claim 1, wherein the sorbent of the sorbent beds comprises sorbent beads having a sorbent bead size <5 mm.

10. The sorbent unit according to-any of the preceding claims claim 1, wherein the sorbent of the sorbent beds is selected from the group of CO₂ sorbent, H₂O sorbent, zeolite, silica gel, or other solid absorbent.

11. The sorbent unit according to any of the preceding claims claim 1, wherein the sorbent of the sorbent beds is zeolite 13×.

12. The sorbent unit according to-any of the preceding claims claim 1, wherein the sorbent unit at the bottom is supported by a frame and supports.

13. The sorbent unit according to claim 12, wherein the supports provide an open space between the frame of the sorbent unit and a floor of an enclosure on which the sorbent unit (44) rests to allow distribution of gas feed through the open space under the sorbent unit.

14. The sorbent unit according to any of the preceding claims claim 1, wherein the casing above each sorbent bed is configured to allow filling of extra sorbent above the sorbent beds and thereby allow the sorbent to sink or settle without creating a leakage or short-cut for the gas through the top of the sorbent beds.

15. A system for purification of gas, comprising:
at least one enclosure comprising
a gas feed pipe,
a gas exit pipe, and
at least one sorbent unit according to claim 1.

16. The system according to claim 15, wherein the system is configured to allow gas feed entering the at least one enclosure through the gas feed pipe to flow substantially horizontally through the sorbent beds, wherein the gas is purified, and into the center volume, flowing the purified gas out of the center volume, collecting the purified gas in the gas exit pipe, and flowing the purified gas out of the at least one enclosure.

17. The system according to claim 15, wherein the at least one enclosure comprises two or more sorbent units arranged in parallel.

18. The system according to claim 15,
wherein the system comprises two or more enclosures arranged in series and/or parallel.

19. Method for purifying gas, comprising:
flowing gas into at least one enclosure, wherein the at least one enclosure comprises a gas feed pipe, a gas exit pipe, and at least one sorbent unit according to claim 1;
flowing the gas substantially horizontally through the sorbent beds, wherein the gas is purified, and into the center volume of the sorbent unit;
flowing the purified gas substantially vertically out of the center volume, collecting the purified gas in a gas exit pipe, and flowing the purified gas out of the at least one enclosure.

20. The method according to claim 19, wherein gas flows through the sorbent beds from at least two opposite directions and into the center volume.

21. The method according to claim 19-or-20, wherein, when two enclosures (38) are run in parallel, the two enclosures (38) alternate between adsorption and desorption modes.

22. The method according to claim 19,
wherein flowing of the gas in the system is effected by fans.
